(19) United States
(12) Patent Application Publication
(10) Pub. No.: US 2010/0179715 A1
(43) Pub. Date: Jul. 15, 2010

(54) CONTROLLING AN AUTONOMOUS VEHICLE SYSTEM

(75) Inventor: John David Puddy, Bristol (GB)

Correspondence Address: PILLSBURY WINTHROP SHAW PITTMAN, LLP, P.O. BOX 10500, MCLEAN, VA, 22102, US

(73) Assignee: BAE SYSTEMS plc, London (GB)

(21) Appl. No.: 12/092,176

(22) PCT Filed: Dec. 5, 2007
(86) PCT No.: PCT/GB07/50740

§ 371 Date: Apr. 30, 2008

(30) Foreign Application Priority Data
Dec. 11, 2006 (EP) 06270099.2
Dec. 11, 2006 (GB) 0624610.2

(51) Int. Cl. G05D 1/00

(52) U.S. Cl. 701/23

(57) ABSTRACT

A system is adapted to transfer control of movement of a vehicle to and/or from an autonomous vehicle system. The control system includes an activation sub-system that has an input device configured to receive an activation signal indicating that an autonomous vehicle system is to be activated. A test device checks, upon receipt of the activation signal by the input device, if the autonomous vehicle system is in a ready state to be activated. If so, an activation device can activate the autonomous vehicle system. The system may also include at least one deactivation switch that is configured, upon being switched on, to deactivate an autonomous vehicle system from controlling movement of the vehicle.

The present invention relates to controlling an autonomous vehicle system.

Autonomous, or unmanned, vehicles are fitted with systems that control the maneuvering of the vehicles without requiring human intervention. Existing examples of such vehicles include “Predator” and “Global Hawk”, which are unmanned air vehicles. More recently, having the option of activating a system that automates the movement of a vehicle that can also be driven/piloted by a human operator has also become desirable. Clearly, it is important that such an autonomous vehicle system includes rigorous safety precautions.

According to a first aspect of the present invention there is provided a system adapted to transfer control of movement of a vehicle to and/or from an autonomous vehicle system, the control system including:

an activation sub-system including:

an input device configured to receive an activation signal indicating that an autonomous vehicle system is to be activated;

a test device configured to check, upon receipt of the activation signal by the input device, if the autonomous vehicle system is in a ready state to be activated, and

an activation device configured to activate the autonomous vehicle system only if the check performed by the test device indicates that the autonomous vehicle system is in the ready state,

and/or a deactivation sub-system including:

at least one deactivation switch that is configured, upon being switched on, to deactivate an autonomous vehicle system from controlling movement of the vehicle.

The activation device may be configured to receive a further activation signal and, upon receipt of the further activation signal, activate the autonomous vehicle system. The activation device may be configured to apply power to (activation coils of) at least one relay (or switch) connected to the autonomous vehicle system. The activation device may include a common actuation line used to apply power to (activation coils of) a plurality of the relays.

The relays may be configured to control motion and directional controls of the vehicle. The motion controls may include throttle and/or brake controls. The directional control may include steering control.

The test device may include a component configured to check if an electrical signal is being output by the autonomous vehicle system.

Activation of a said deactivation switch can allow the vehicle to be controlled by at least one human-operated controller instead of the autonomous vehicle system. A said deactivation switch may be configured to be connected to a motion controller (e.g. a throttle and/or brake control) of the vehicle such that when the motion controller is used the deactivation switch is switched on. Additionally or alternatively, a said deactivation switch may be configured to be connected to a directional controller (e.g. a steering control) of the vehicle such that when the directional controller is used the deactivation switch is switched on.

According to another aspect of the present invention there is provided a system adapted to control an autonomous vehicle system, the control system including:

an input device configured to receive an activation signal indicating that an autonomous vehicle system is to be activated;

a test device configured to check, upon receipt of the activation signal by the input device, if the autonomous vehicle system is in a ready state to be activated, and

an activation device configured to activate the autonomous vehicle system only if the check performed by the test device indicates that the autonomous vehicle system is in the ready state.

According to a further aspect of the present invention there is provided a method of controlling an autonomous vehicle system, the method including:

receiving an activation signal indicating that an autonomous vehicle system is to be activated;

checking, upon receipt of the activation signal, if the autonomous vehicle system is in a ready state to be activated, and

activating the autonomous vehicle system only if the check performed by the test device indicates that the autonomous vehicle system is in the ready state, and/or:

receiving a signal from at least one deactivation switch that is configured, upon being switched on, to deactivate an autonomous vehicle system from operating the vehicle.

According to another aspect of the present invention there is provided a system adapted to control an autonomous vehicle system, the control system including:

at least one deactivation switch that is configured, upon being switched on, to deactivate an autonomous vehicle system from controlling movement of the vehicle.

According to another aspect of the present invention there is provided an autonomous vehicle system including a control system substantially as described herein. According to yet another aspect of the present invention there is provided a vehicle including an autonomous vehicle system and a control system substantially as described herein.

Whilst the invention has been described above, it extends to any inventive combination of the features set out above or in the following description. Although illustrative embodiments of the invention are described in detail herein with reference to the accompanying drawings, it is to be understood that the invention is not limited to those precise embodiments. As such, many modifications and variations will be apparent to practitioners skilled in this art. Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described, reference being made to the accompanying drawings, in which:

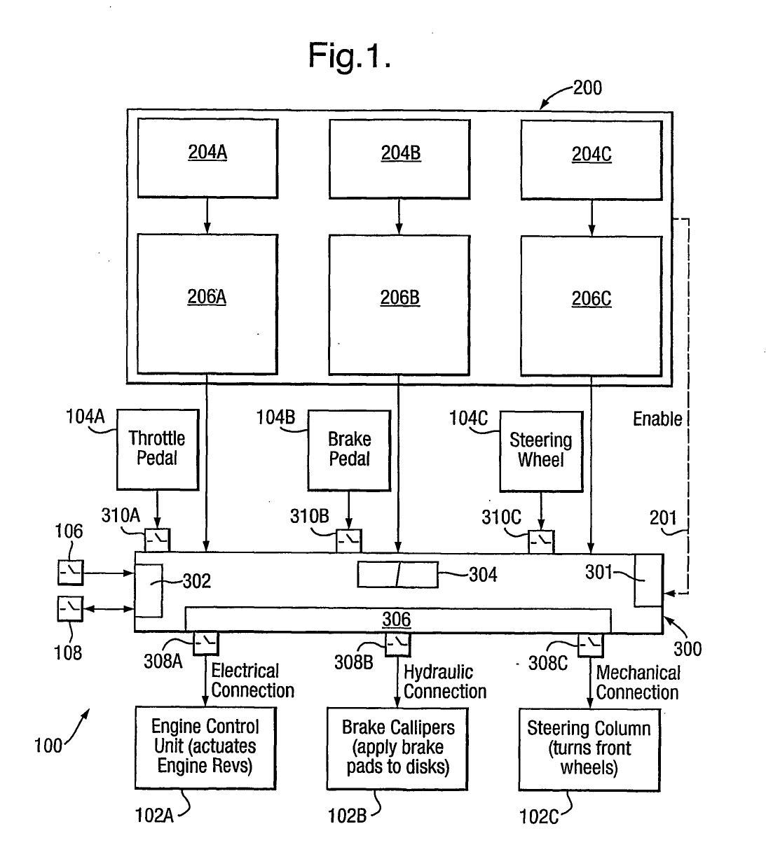

FIG. 1 is a schematic diagram of a vehicle including an autonomous vehicle system and a system for controlling the autonomous vehicle system;

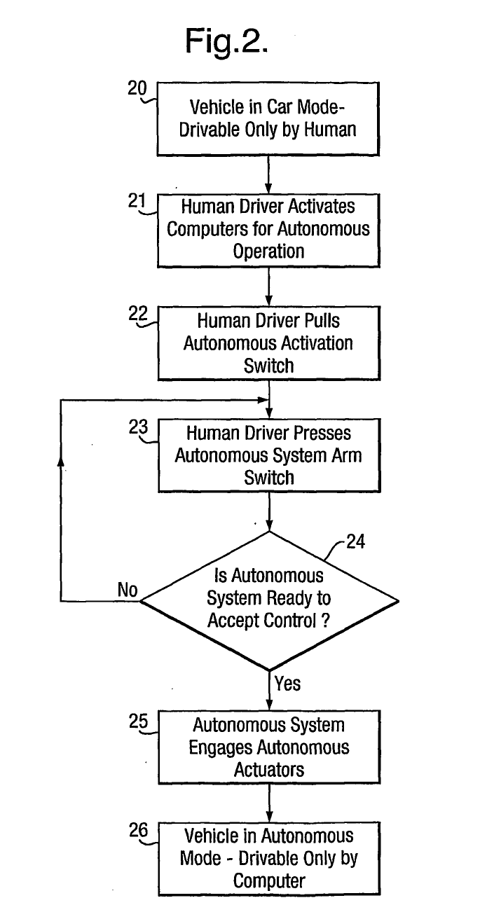

FIG. 2 illustrates schematically steps performed by the control system to activate the autonomous vehicle system, and

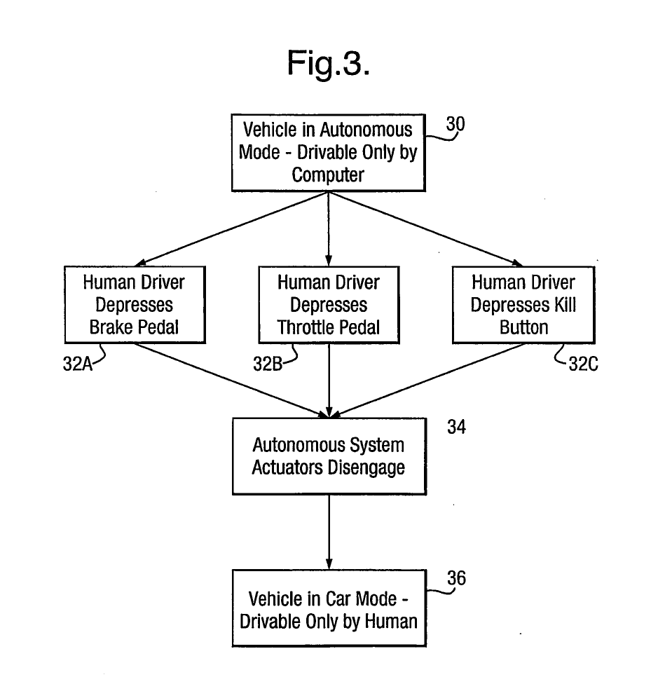

FIG. 3 illustrates schematically steps performed by the control system to deactivate the autonomous vehicle system.

FIG. 1 shows a block diagram of a vehicle 100 that is fitted with an autonomous vehicle system 200. It will be appreciated that the diagram is simplified and does not show all components of the vehicle and concentrates on those with which the autonomous system 200 is concerned. The vehicle in the example is a land-based vehicle and so includes components commonly found in that type of vehicle, such as a set of wheels (not shown) for traction, but it will be understood that the system described herein could be implemented on other types of vehicles.

The vehicle 100 includes various components for implementing movement of the vehicle. In the example these include an Engine Control Unit (ECU) 102A (that actuates revs of the engine), brake calipers 102B (that apply brake pads to brake disks) and a steering column 102C (that turns the front wheels of the vehicle). It will be appreciated that these movement components are exemplary only and variations are possible, including suitable components for vehicles configured to move through air or water, e.g. thrusters or rudders.

Human-operated controllers for controlling the movement components discussed above are provided for use when the vehicle is under the control of a driver rather than the autonomous system 200. In the example, throttle pedal 104A, brake pedal 104B and steering wheel 104C control the ECU 102A, brake calipers 102B and steering column 102C, respectively. Again, it will be appreciated that these controllers are exemplary only and that other types may be provided, e.g. a joystick.

As in other, conventional ground vehicles, the steering wheel 104C is mechanically connected to the front wheels by means of the steering column 102C. Turning the wheel 104C has the effect of turning the front wheels to the left or right. Throttle demand is issued via the human driver depressing the throttle pedal 102A, which coverts the throttle position into an electronic value and passes this to the ECU 102A, which then implements appropriate (manufacturer-specific) engine control to increase engine revolutions. Vehicle braking is achieved by the driver depressing the brake pedal 102B, generating hydraulic pressure in the brake master cylinder, this pressure being transferred to the brake calipers 102B via hydraulic hoses, and having the effect of pushing brake pads in contact with the brake disk.

The vehicle 100 also includes at least one controller 106 for allowing a human to indicate that control of the movement of the vehicle is to be transferred to the autonomous system 200 (instead of it being maneuvered using the human-operated controllers 104). The transfer controller 106 may be a button, switch or the like located on a dashboard of the vehicle, but it will be understood that other mechanisms could be used, e.g. electronic voice control or remote control.

The example vehicle also includes a further transfer controller or “arm” switch 108. The intention is that a human operator initially uses the first transfer controller 106, which is connected to a control system 300 for the autonomous system 200. Upon receiving a signal initiated by the first transfer controller 106 the control system 300 operates as described below to check if it is safe to transfer control to the autonomous system 200. If so, the operator can then use the further transfer controller 108 to actually transfer control/activate the autonomous system 200. It will be understood that the further transfer controller 108 is optional and simply using the first transfer controller 106 to activate the control system 300 which can then directly activate (without using the further transfer controller) the autonomous system 200, if appropriate, is possible.

Turning to the autonomous system 200, this contains several components, including a computer that is configured to control the parameters of throttle, steering and braking of the vehicle 100. Existing examples of autonomous systems include ones fitted in vehicles participating in the DARPA Grand Challenge event (although these vehicles are purely autonomous and do not have the facility to switch to a human driver). Some of these autonomous systems are well documented and so need not be described in detail here. The autonomous system 200 includes actuators for the movement components 102 of the vehicle 100 to allow them to be controlled by code executing on a computer processor that is part of the system 200.

The system 200 can comprise several modules, each of which is responsible for controlling one of the throttle, brake and steering movement components of the vehicle; however, it will be appreciated that the system need not always be configured in this way, e.g. if the movement components of a vehicle do not include a braking arrangement. The computer module 204A interfacing to the throttle control actuator 206A can be achieved by connecting analog electrical outputs to the ECU 102A, with the computer converting a software prescribed percentage into an analog value at the ECU via digital (software value) to analog conversion hardware in module 206A. Braking control module 204B can be implemented by the installation of electro-hydraulic valves within the brake hydraulics, with these electro-hydraulic valves converting an analog electrical signal from a braking control actuator 206B into hydraulic pressure at the brake calipers 102B. This braking controller tunes the braking profile between the front and rear wheels to manage vehicle traction, with the braking controller in turn receiving analog values representing overall braking percentage from the system computer.

Steering control may be implemented by installing a Servomotor onto the steering column 102C between the steering wheel 104C and the steering rack. Analog electrical signals representing position of the vehicle wheels are output from the computer module 204C and these interpreted via a steering control actuator 206C into a position of the steering motor. The steering motor is then turned via analog electrical signals passed from the steering controller 206C to the steering motor.

The system 300 for controlling activation and deactivation of the autonomous system 200 is connected to the actuator components 206A-206C of the autonomous system 200 and uses a number of electric relays 308 to ensure that movement commands cannot be sent from both the human-operated controllers 104 and the computer of the autonomous system 200 at the same time. The control system 300 includes an input/output component 302 that can communicate with the transfer controllers/switches 106, 108 of the vehicle. The control system further includes processor/memory 304 and an input component 301 for receiving a state signal from the autonomous system 200. Also included in the control system is a common actuation line 306 that is connected to the relays 308. The control system 300 further includes a set of switches 310A-310C connected to the human-operated controllers 104A-104C.

Referring to FIG. 2, steps involved in transferring control of movement of the vehicle from a human operator to the autonomous system 200 are shown. At step 20 the vehicle 100 is in “car mode”, i.e. a human driver directs movement of the vehicle using the controllers 104. At step 21 a human operator (who may or may not be the driver) decides (or may be informed in some way, e.g. by means of a prompt on a computer-controlled display) that the autonomous system 200 is to be activated and switches on power to the autonomous system 200 (if it is not already on). At step 22 the operator indicates to the control system 300 that there is a desire to activate the autonomous system 200 by pulling the first transfer switch 106. At step 23 the operator presses the further (“arm”) transfer controller 108 to indicate that he is fully ready for the autonomous system 200 to take over control of the movement of the vehicle 100.

After the control system 300 has received signals via its input component 302 that the first switch 106 and the further switch 108 have been pulled, at step 24 its processor/memory 304 executes code that checks if a signal is being received at input component 301. The signal is generated by the autonomous system 200 as an indication that is in a ready state to take over control of the vehicle. This signal may be generated upon instruction by the processor. The signal can be in many forms. For example, it may be an electrical signal that is passed to a digital-to-analog board connected to the processor. The board can then output an analog signal as a “high voltage” state. Such a signal can be used to activate a relay. Alternatively, a purely digital signal could be used.

If no signal is received (or, alternatively, a signal indicating that the autonomous system 200 is not ready to be activated is received at 301) then this indicates that the autonomous system 200 is not ready to take over control of the vehicle. In this case, the control system passes back to step 23, at which point the operator must again pull the further transfer switch 108 in order to attempt to activate the autonomous system. Thus, the operator depressing the further switch 108 prior to the autonomous system 200 being ready will not be able to activate the autonomous system.

On the other hand, if a signal 201 is received at step 23 that indicates that the autonomous system 200 is ready then control passes to step 25, where the modules of the autonomous system are allowed to engage with the relays/actuators 308 of the movement components 102. A signal may be given to the driver of the vehicle, e.g. lighting up the arm button 108, to indicate that the vehicle is in autonomous mode. At this point the control system 300 applies power to the activation coils of the relays 308. The relay 308A switches the ECU 102A to receive input from the output of the computer module 204A upon this transfer to autonomous mode (instead of from the throttle pedal 104A when the vehicle is in “car” mode). The relay 308B is used to apply electrical power to the braking control actuator 206C upon transfer of the vehicle to autonomous mode. Thus, when the vehicle is in car mode the braking controller does not have any power. The relay 308C is used to apply electrical power to the steering control actuator 206C attached to the steering column 102C when in autonomous mode. Thus, when the vehicle is in car mode, the steering controller does not have power. Having all the relays 308 connected via the common actuation line 306 means that all the relays activate at substantially the same time.

FIG. 3 shows steps involved in transferring control of movement of the vehicle from the autonomous system 200 to the human operator, (i.e. from autonomous mode to car mode). Such a deactivation sub-system may be optionally installed in a vehicle having an activation sub-system as described above. At step 30 the vehicle is in the autonomous mode and transfer of the vehicle to car mode can result from one or more of the events of any of steps 32A 32C. For example, at step 32A the driver depresses the brake pedal 104B, which changes the state of the switch 3108. The control system 300 receives a signal indicating this change and at step 34 the actuators of the autonomous system 200 are disengaged (with the vehicle is shown as being in car mode again at step 36). That is, the relay 308A switches the ECU 102A to receive input from the throttle pedal 104A; the relay 308B removes electrical power from the braking control actuator 206B and the relay 308C removed power from the steering control actuator 206C attached to the steering column 102C. Again, the common actuation line 306 causes all these relays to switch off at substantially the same time. In a similar manner these deactivation steps can result from the driver pressing the throttle pedal 104A (leading to switch 310A changing state), or from the driver rotating the steering wheel 104C (leading to switch 310C changing state). In an alternative embodiment, a deactivation switch can be located within the vehicle (e.g. mounted on the dashboard) for direct control by a human operator in addition to, or instead of, the switches 310.

Thus, the control system 300 is designed such that having pressed any pedal/steering wheel to return control of the vehicle to the human driver. Upon release of the pedal/steering wheel, the actuator relays remain inactive until the human operator again transfers control to the autonomous system 200 as described above with reference to FIG. 2.

1. A system adapted to transfer control of movement of a vehicle to and/or from an autonomous vehicle system, the transfer control system including:
(a) an activation sub-system including:
(i) an input device configured to receive an activation signal indicating that an autonomous vehicle system is to be activated;
(ii) a test device configured to check, upon receipt of the activation signal by the input device, if the autonomous vehicle system is in a ready state to be activated, and
(iii) an activation device configured to activate the autonomous vehicle system only if the check performed by the test device indicates that the autonomous vehicle system is in the ready state,
and/or (b) a deactivation sub-system including:
at least one deactivation switch that is configured, upon being switched on, to deactivate an autonomous vehicle system from controlling movement of the vehicle.

2. A system according to claim 1, wherein the activation device includes an arrangement configured to enable a further input device to receive a further activation signal and, upon receipt of the further activation signal, activate the autonomous vehicle system.

3. A system according to claim 1, wherein the activation device is configured to apply power to at least one relay connected to the autonomous vehicle system.

4. A system according to claim 3, wherein the activation device includes a common actuation line used to apply power to a plurality of the relays.

5. A system according to claim 1, wherein the test device includes a component configured to check if an electrical signal is being output by the autonomous vehicle system.

6. A system according to claim 1, wherein activation of a said deactivation switch allows the vehicle to be controlled by at least one human-operated controller instead of the autonomous vehicle system.

7. A system according to claim 1, wherein a said deactivation switch is configured to be connected to a motion controller of the vehicle such that when the motion controller is used, the deactivation switch is switched on.

8. A system according to claim 1, wherein a said deactivation switch is configured to be connected to a directional controller of the vehicle such that when the directional controller is used, the deactivation switch is switched on.

9. An autonomous vehicle system including a transfer control system according to claim 1.

10. A method of controlling an autonomous vehicle system, the method including:
receiving an activation signal indicating that an autonomous vehicle system is to be activated;
checking upon receipt of the activation signal, if the autonomous vehicle system is in a ready state to be activated, and
activating the autonomous vehicle system only if the check performed by the test device indicates that the autonomous vehicle system is in the ready state, and/or the method including:
receiving a signal from at least one deactivation switch that is configured, upon being switched on, to deactivate an autonomous vehicle system from operating the vehicle.

11-12. (canceled)
